(19) United States
(12) Patent Application Publication
(10) Pub. No.: US 2002/0069112 A1
(43) Pub. Date: Jun. 6, 2002

(54) Service alert agent for a computer system

(75) Inventors: Sanaa F. Abdelhadi, Austin, TX (US); Hypatia Rojas, Round Rock, TX (US)

Correspondence Address: Edmond A. DeFrank, 20145 Via Medici, Northridge, CA, 91326, US

(73) Assignee: International Business Machines Corporation

(21) Appl. No.: 09/730,422

(22) Filed: Dec. 4, 2000

(51) Int. Cl. G06F 17/60

(52) U.S. Cl. 705/23

(57) ABSTRACT

The present invention is embodied in a system and method for providing easy and convenient access to product indicia for computer related products with a service alert agent that incorporates important indicia about the product and can be easily accessed from a single area. In general, the present invention is an electronic service alert agent for providing complete access to information that can be used to identify the product, such as serial number, model number, product number, configuration specifications, etc. In one embodiment, the service alert agent is incorporated in the manufacturers external logo, which is typically imprinted on a clearly visible portion of the product. As a result, the user can easily access all the important product indicia via the clearly visible logo of the particular manufacturer.

### BACKGROUND OF THE INVENTION

1. Field of the Invention

The present invention relates in general to computer related products and systems and in particular to a system and method for providing easy and convenient access to product indicia with an electronic service alert agent for computer related products.

2. Related Art

Computer systems are a regular part of the everyday lives of many people. Computer systems are typically used in one's home as well as one's business or work place. A computer system typically consists of a main board having a central processing unit (CPU) and storage devices, such as a hard drive and/or CD ROM drive. Most computer systems also include a monitor, keyboard and some other type of input device, such as a mouse. The computer monitor has a display screen for displaying information, usually in graphical format, to the user. The keyboard and mouse are used to interface a user with the computer.

Most computer related products are associated with a serial number, model number, product number, configuration specifications and/or other information that are used to identify the product. Identification of computer related products is especially important when a user of a computer related product contacts the manufacturer and/or the technical support or customer service department of the particular computer related product. Typically, these departments require the user to provide some or all of the identifying information associated with the computer related product.

However, the identifying information of computer related products are usually not in a single area that is easily accessible by the user. For example, some information is imprinted on inconvenient areas, such as the back or the bottom of the product. Other information can only be accessed when the computer related product is operating, which can be a problem if the user cannot get the product operating. Consequently, this can create a problem, especially if the user is caught off guard and not prepared to provide this required information when making a call for help to the manufacturer because he/she cannot find it. This can cause additional frustration by the user and psychological distaste for the product and the manufacturer, which can lead to overall reduced customer satisfaction.

Therefore, what is needed is a system and method that provides easy and convenient access to product indicia. What is also needed is an electronic service alert agent that provides single access to information to identify the product, such as serial number, model number, product number, configuration specifications, etc. What is further needed is a service alert agent that is incorporated in a clearly visible portion of the product.

### SUMMARY OF THE INVENTION

To overcome the limitations in the prior art described above, and to overcome other limitations that will become apparent upon reading and understanding the present specification, the present invention is embodied in a system and method for providing easy and convenient access to product indicia for computer related products with an electronic device. The service alert agent incorporates important indicia about the product and can be easily accessed from a single area.

In general, the present invention is an electronic service alert agent for providing complete access to information that can be used to identify the product, such as serial number, model number, product number, configuration specifications, etc. In one embodiment, the service alert agent is incorporated in the manufacturers external logo, which is typically a small logo fixture that is attached to an external portion of the product on a clearly visible portion of the product. The logo can be an electronic device with a button that is easily depressed by the user. As a result, when depressed, the user can easily access all the important product indicia via the clearly visible logo of the particular manufacturer.

Specifically, the service alert agent includes a memory device, an audible system, including a microphone and a speaker and a power source. The memory device provides a storage area that has product indicia recorded at the manufacturing stage. In addition, the memory device can record and store new indicia or reminders that the user desires to include in the service agent for easy access. The speaker allows the indicia to be audibly broadcast to the user or the technical support and/or customer service operator with a prerecorded human voice or a synthesized recording when the service alert agent logo is accessed.

These components allow the service agent to operate independently from the computer system. For example, the power source can independently power the service agent and allows accessibility to the service agent even when the computer system is inoperable. Alternatively, the service alert agent can have a processor for allowing electronic connectivity to the computer system. This provides the service alert agent with send and receive capabilities to allow sharing of information between the computer system and the service alert agent.

The present invention as well as a more complete understanding thereof will be made apparent from a study of the following detailed description of the invention in connection with the accompanying drawings and appended claims.

### BRIEF DESCRIPTION OF THE DRAWINGS

Referring now to the drawings in which like reference numbers represent corresponding parts throughout:

FIG. 1 illustrates a conventional hardware configuration for use with the present invention.

FIG. 2 is a general pictorial block diagram showing an overview of the present invention.

FIG. 3 is a detailed block/flow diagram showing a working example of the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Introduction

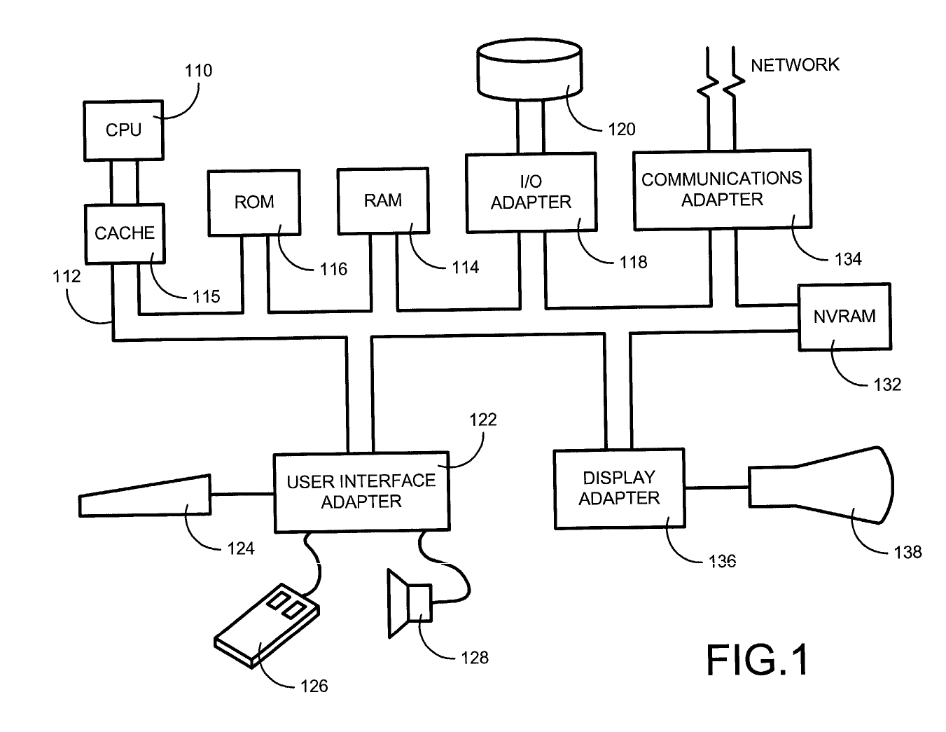

The preferred embodiments may be practiced in any suitable hardware configuration that uses a networked connection, such as computing system 100 illustrated in FIG. 1 or, alternatively, in a laptop or notepad computing system. Computing system 100 includes any suitable central processing unit 110, such as a standard microprocessor, and any number of other objects interconnected via system bus 112.

For purposes of illustration, computing system 100 includes memory, such as read only memory (ROM) 116, random access memory (RAM) 114, and peripheral memory devices (e.g., disk or tape drives 120) connected to system bus 112 via I/O adapter 118. Computing system 100 further includes a display adapter 136 for connecting system bus 112 to a conventional display device 138. Also, user interface adapter 122 could connect system bus 112 to other user controls, such as keyboard 124, speaker 128, mouse 126, and a touchpad (not shown).

One skilled in the art readily recognizes how conventional computers and computer programs operate, how conventional input device drivers communicate with an operating system, and how a user conventionally utilizes a input devices to initiate the manipulation of objects in a graphical user interface.

A graphical user interface (GUI) and operating system (OS) of the preferred embodiment reside within a computer-readable media and contain device drivers that allows one or more users to initiate the manipulation of displayed object icons and text on a display device. Any suitable computer-readable media may retain the GUI and operating system, such as ROM 116, RAM 114, disk and/or tape drive 120 (e.g., magnetic diskette, magnetic tape, CD-ROM, optical disk, or other suitable storage media).

In the preferred embodiments, the COSE.TM. (Common Operating System Environment) desktop GUI interfaces the user to the AIX.TM. operating system. The GUI may be viewed as being incorporated and embedded within the operating system. Alternatively, any suitable operating system or desktop environment could be utilized. Examples of other GUIs and/or operating systems include X11.TM. (X Windows) graphical user interface, Sun's Solaris.TM.operating system, and Microsoft's Windows 95.TM. operating system. While the GUI and operating system merely instruct and direct CPU 110, for ease in explanation, the GUI and operating system will be described as performing the following features and functions.

II. General Overview of the Components and Operation

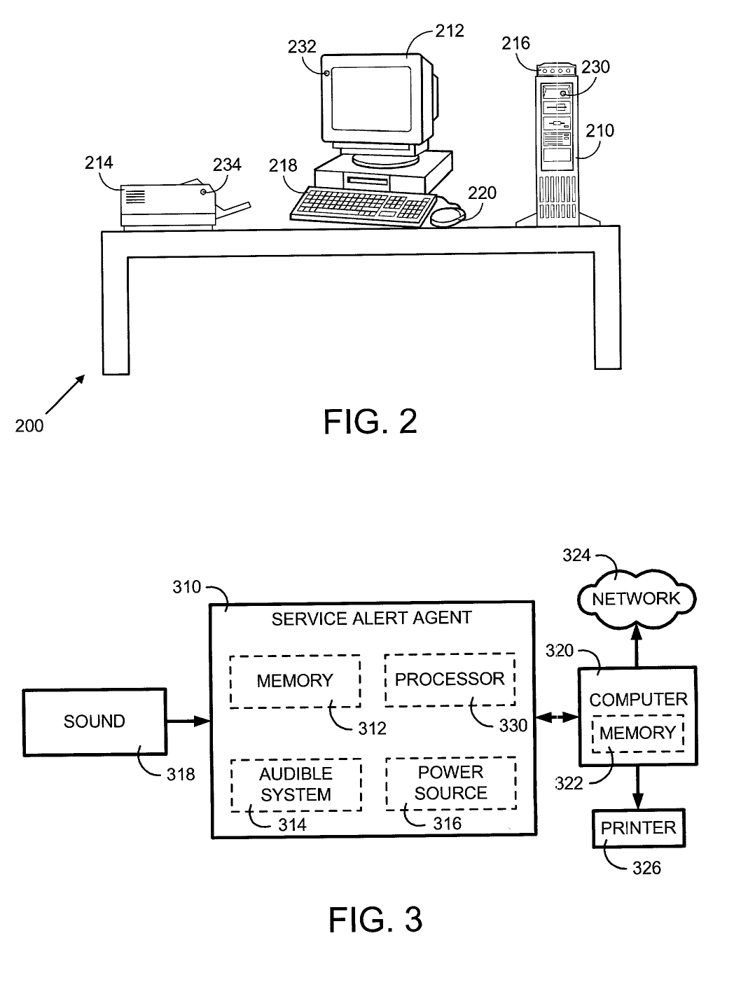

FIG. 2 is a general pictorial block diagram showing an overview of the present invention. In general, the present invention operates in a computer related environment 200 that includes a computer 210, a monitor 212, a printer 214, a modem 216, and input devices 218, 220, such as a keyboard and a mouse, as shown in FIG. 2. Service alert agents 230, 232, 234 can be incorporated for each computer related product for electronically providing respective product indicia, such as product serial number, model number, product number, configuration specifications and/or other information that are used to identify the product. It should be noted that the present invention works with any product, including, but not limited to non-computer related products such as household appliances, manufacturing equipment for factories, automobiles and automotive devices, mobile devices, aircraft equipment, etc.

In one embodiment, the service alert agents 230, 232, 234 are preferably external electronic devices for providing easy and convenient access to the respective product indicia. For example, each service alert agent can be incorporated in the respective manufacturers' external logo, which is typically a small logo fixture that is attached to an external portion of the product on a clearly visible portion of the product. The logo can be an electronic device with a button that is easily depressed by the user. As a result, when depressed, the user can easily access all the important product indicia via the clearly visible logo of the particular manufacturer.

In operation, the service alert agents 230, 232, 234 aid a user during product problems. For instance, identification of computer related products is important when the user contacts the manufacturer and/or the technical support or customer service department of the particular computer related product. These departments usually require some or all of the identifying information associated with the computer related product.

With the service alert agents 230, 232, 234 of the present invention, product information is easily provided during a customer service or technical support telephone call, even if the product is not operating. The user can depress the service alert agent button and the product indicia can be audibly conveyed to the service agent. Consequently, the user will never be caught off guard and will be prepared to provide this required information when making the call to the manufacturer for help. This can ease the user's frustration and create psychological satisfaction for the product and the manufacturer, which can lead to overall increased customer satisfaction.

III. Details of the Components

FIG. 3 is a detailed block/flow diagram showing a working example of the present invention. Specifically, service alert agent 310, which is similar to service alert agents 230, 232, 234 of FIG. 2, includes a memory device 312, an audible system 314, including a microphone and a speaker and a power source 316.

The memory device 312 provides a storage area for the product indicia, preferably in read only memory (ROM) that is recorded at the manufacturing stage. Other information, such as warranty information, helpful phone numbers, frequently asked questions, tips, technical advice, etc., as well as product indicia can also be recorded onto the memory device. A prerecorded human voice or synthesized recording can be stored in the memory including the product indicia and other information for audible playback. The prerecorded human voice can be recorded in several different languages, depending on the country the product is used in or the spoken language of the customer service agents.

In addition, the memory device 312 can record sound 318 from a user via the microphone and store in random access memory (RAM), such as flash RAM, new indicia or reminders that the user desires to include in the service agent 310 for easy access. Also, the memory device can store a service history list. The speaker allows the indicia to be audibly broadcast to the user or the technical support and/or customer service operator with the prerecorded human voice when the service alert agent logo is accessed.

These components allow the service agent 310 to operate independently from the computer system 320, which is similar to computer 210 of FIG. 1. The computer system includes memory 322 and can be coupled to a network 324 and a printer 326. The power source 316 can independently power the service agent 310 and allows accessibility to the service alert agent 310 even when the computer system 320 is inoperable.

In addition, the service alert agent 310 can have a processor 330 for allowing electronic and digital connectivity to the computer system 320. With this arrangement, the service alert agent 310 is empowered with send and receive capabilities to allow sharing of information between the computer system 320 and the service alert agent 310. For example, the service alert agent can access or be accessed by the memory 322 of the computer. This allows automatic and electronic maintenance, checking and/or updating of the service alert agent 310.

Next, the service alert agent can access the printer 326 to allow printouts and hard copies of the product indicia. Further, since the computer 320 is connected to the network 324, remote accessibility is provided to and from the service alert agent. In other words, the service alert agent 310 can interact with the others, such as remote customer service or technical representatives of the manufacturer or service center via the computer system 310 and the network 324.

The foregoing description of the invention has been presented for the purposes of illustration and description and is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A service alert agent for providing access to product information for a computer related product, comprising:
a memory device that stores the product information and being located on an external portion of the computer related product; and
an audio device that audibly conveys the product information stored in the memory device.

2. The service alert agent of claim 1, further comprising a recording device that records audio and stores the audio in the memory device.

3. The service alert agent of claim 1, wherein the audio device audibly conveys the product information in more than one spoken language.

4. The service alert agent of claim 1, further comprising a power source for independently powering the service alert agent.

5. The service alert agent of claim 1, wherein the audio device comprises a microphone and a speaker.

6. The service alert agent of claim 1, further comprising a processor that digitally connects the service alert agent to a computer system.

7. The service alert agent of claim 6, wherein the processor enables send and receive capabilities to allow sharing of information between the computer system and the service alert agent.

8. The service alert agent of claim 7, wherein the service alert agent communicates with a memory device of the computer system to allow automatic and electronic maintenance, checking and updating of the service alert agent.

9. The service alert agent of claim 7, wherein the service alert agent communicates with a printer to allow printouts and hard copies of the product information.

10. The service alert agent of claim 7, further comprising a network connectivity of the computer related product to allow remote accessibility to and from the service alert agent.

11. The service alert agent of claim 1, wherein the service alert agent is remotely accessible by representatives of the computer related product.

12. The service alert agent of claim 1, wherein the memory device is capable of recording and storing each service on the product for creating a service history list.

13. The service alert agent of claim 1, wherein the product information includes at least one of the serial number of product, important technical support and customer service phone numbers related to the product, product warranty information, product tips, product advice or frequently asked questions.

14. A method for providing access to product information for a computer related product, comprising:
storing the product information on an electronic device located on an external portion of the computer related product; and
audibly conveying the product information stored in the memory device.

15. The method of claim 14, further comprising recording audio and storing the audio.

16. The method of claim 14, further comprising conveying the product information in more than one spoken language.

17. The method of claim 14, further comprising independently powering the service alert agent.

18. The method of claim 14, further comprising digitally connecting the service alert agent to a computer system.

19. The method of claim 18, further comprising sharing information between the computer system and the service alert agent.

20. The method of claim 18, further comprising communicating with a memory device of the computer system to allow automatic and electronic maintenance, checking and updating of the service alert agent.

21. The method of claim 18, further comprising communicating with a printer to allow printouts and hard copies of the product information.

22. The method of claim 18, further comprising providing network connectivity of the computer related product to allow remote accessibility to and from the service alert agent.

23. The method of claim 14, further comprising providing remote accessibility by representatives of the computer related product.

24. The method of claim 14, further comprising recording and storing each service on the product for creating a service history list.

25. The method of claim 14, wherein the product information includes at least one of the serial number of product, important technical support and customer service phone numbers related to the product, product warranty information, product tips, product advice or frequently asked questions.

26. An electronic device that provides access to product information for a product, comprising:
a memory device located on an external portion of the computer related product and having stored therein the product information;
an audio device that audibly conveys the product information stored in the memory device; and
a recording device that records audio and stores the audio in the memory device.

27. The electronic device of claim 26, wherein the audio device audibly conveys the product information in more than one spoken language.

28. The electronic device of claim 26, wherein the electronic device is remotely accessible by representatives of the product.

29. The electronic device of claim 26, wherein the memory device is capable of recording and storing each service on the product for creating a service history list.

30. The electronic device of claim 26, wherein the product information includes at least one of the serial number of product, important technical support and customer service phone numbers related to the product, product warranty information, product tips, product advice or frequently asked questions.
